(19) United States
(12) Patent Application Publication
(10) Pub. No.: US 2004/0189836 A1
(43) Pub. Date: Sep. 30, 2004

(54) System and method for compensating for noise in image information

(76) Inventors: Kurt E. Spears, Fort Collins, CO (US); Kip O. Morgan, Laporte, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/396,972

(22) Filed: Mar. 25, 2003

(51) Int. Cl. H04N 5/217

(52) U.S. Cl. 348/241

(57) ABSTRACT

A system and method that compensates for noise in image information. The method comprises receiving test information for a plurality of pixels, determining a base compensating value based upon the test information, determining a plurality of differential compensating values, each differential compensating value based upon a difference between the test information for each of the corresponding pixels and the base compensating value, and storing the base compensating value and the plurality of differential compensating values.

### BACKGROUND OF THE INVENTION

1. Field of the Invention

The present invention generally relates to digital-based imaging devices and, in particular, to a system and method for compensating for noise in image information.

2. Related Art

With the advent of digitally-based imaging devices capable of scanning and capturing an image, complex systems and methods have been developed to improve the quality of the captured image. One exemplary digitally-based imaging device is a scanner. One embodiment of a black-and-white scanner employs at least one linear array of pixels, referred to as a linear charged-coupled device (CCD). A color scanner employs color-sensitive linear CCDs, such as linear CCDs sensitive to green, red and blue. Matrix CCDs, also known as area CCDs, are similarly configured into a matrix of pixel rows and pixel columns. For example, a digital camera employs a matrix CCD comprised of color-sensitive pixels.

Such CCD devices are configured to compensate, calibrate and/or reduce non-uniformities due to variations between the light information collected by individual pixels. Such variations in the collected light information, if not corrected, will cause undesirable variations in the appearance of the processed image. For example, a region of an original image having a uniform color can appear to have color variations in the same region of the reproduced image.

Thermal noise may cause some pixels to accumulate charge even in the absence of light. Prior to capturing an image, a calibration test is conducted to determine thermal noise accumulated by the pixels. During this calibration test no light is present. That is, no light is available for detection by the pixels residing in the linear CCD. Accordingly, each pixel is expected to provide an output of 0 bits in the absence of thermal noise. However, some pixels accumulate charge due to thermal noise.

### SUMMARY

Generally, one embodiment of the present invention compensates for noise in image information. The method comprises receiving test information for a plurality of pixels, determining a base compensating value based upon the test information, determining a plurality of differential compensating values, each differential compensating value based upon a difference between the test information for each of the corresponding pixels and the base compensating value, and storing the base compensating value and the plurality of differential compensating values.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating an embodiment of an image capture device having a charge-coupled device (CCD) according to the present invention.

FIG. 2 is a block diagram illustrating an embodiment of an image capture device.

FIG. 3 is a block diagram illustrating an embodiment of a control application specific integrated circuit (ASIC).

FIGS. 4A and 4B show a flow chart illustrating a process, according to the present invention, for compensating dark signal non-uniformity (DSNU) noise and photo response non-uniformity (PRNU) noise in the image.

FIG. 5 is a block diagram illustrating another embodiment of an image capture device.

FIG. 6 is a block diagram illustrating another embodiment of an image capture device.

FIG. 7 is a block diagram illustrating another embodiment of an image capture device employing a complimentary metal oxide semiconductor (CMOS) device.

FIGS. 8A and 8B are block diagrams illustrating alternative embodiments of an image capture device employing adders having at least one register.

FIG. 9 shows a flow chart illustrating a process, according to the present invention, for compensating noise in an image.

### DETAILED DESCRIPTION

In general, the present invention is directed to systems and methods for compensating for noise in image information. More particularly, the present invention relates to compensating dark signal non-uniformity (DSNU) noise and/or photo response non-uniformity (PRNU) noise in the image capture device. Hereinafter, the term image capture device refers to any device employing a plurality of pixels to capture an image, such as, but not limited to, a scanner, a facsimile machine (FAX), a digital camera, a copy machine, a printer or the like.

Thermal noise information for each pixel in the linear CCD is used to determine a dark signal non-uniformity (DSNU) offset. For example, one of the pixels may, in the absence of light, collect a charge corresponding to 100 bits. The DSNU offset of 100 bits is determined for that pixel, and saved to memory. Such a memory is referred to a calibration random-access memory (RAM). DSNU offsets are determined for each pixel in the linear CCD and stored in the calibration RAM.

The DSNU offset for a pixel may be relatively large. Without the present invention, a larger memory size must be allocated for the DSNU offsets in the calibration RAM. Furthermore, bandwidth, a term used herein to denote data transmission capacity, must also be provided for the DSNU offsets so that the DSNU offsets are meaningfully and efficiently communicated across the various connections and through the various components.

Another significant source of error is caused by differences in the charge accumulated by individual pixels when a uniform-colored image is present. Thus, when a white image is scanned, the light information collected by each pixel may not be uniform. For example, one pixel may accurately collect light information equal to 100 bits when exposed to an image. However, another pixel may detect light information equal to 110-bits when exposed to the image. Since all portions of the image are the same (a uniform image), the 10-bit difference of collected light information represents noise. Such noise may be the result of a variety of factors. For example, pixels may have differing sensitivity to light as a result of the fabrication process. Or, the light source that is used to apply light to the image may not be uniform across the entire image, thereby causing identical pixels to accumulate different charges.

Accordingly, prior to capturing an image, a light source illuminates a white image or other suitable reference image to cause a reading of the pixels in the linear CCD. Due to the above-described noise, the light information collected by the pixels may vary from pixel to pixel. This light information for each pixel is processed to determine a photo response non-uniformity (PRNU) gain. The PRNU gain, as described in greater detail below, is determined for each pixel.

The PRNU gain for a pixel may be relatively large. Without the present invention, a larger memory size must be allocated for the PRNU gains in the calibration RAM. Bandwidth must also be provided for the PRNU gains so that the PRNU gains are meaningfully and efficiently communicated across the various connections and through the various components.

When an image is scanned, the linear CCD scans one image line. The wide variety of processes for scanning an entire image are known, and are therefore not described in detail herein. However, for each scan line, the collected light information from the linear CCD is compensated by subtracting out the DSNU offset for each pixel. In one embodiment, a digital-to-analog converter (DAC) converts the DSNU offsets into a DSNU offset analog information signal that corresponds to the original light information collected by the pixels. The DSNU offset analog information signal is communicated to an adder so that the corresponding DSNU offset is subtracted from the light information provided by each pixel. Thus, the light information has an increased accuracy because the dark noise for each pixel has been subtracted out of the light information from the scanned image line.

Similarly, PRNU gains are communicated from the calibration RAM to a second DAC. The second DAC 112 converts the PRNU gain into a PRNU gain analog information signal. This PRNU gain analog information signal is communicated to a multiplier. At the multiplier, light information provided by each pixel is multiplied by the corresponding PRNU gain. Thus, the light information has an increased accuracy because the PRNU noise for each pixel has been compensated out of the light information from the scanned image line.

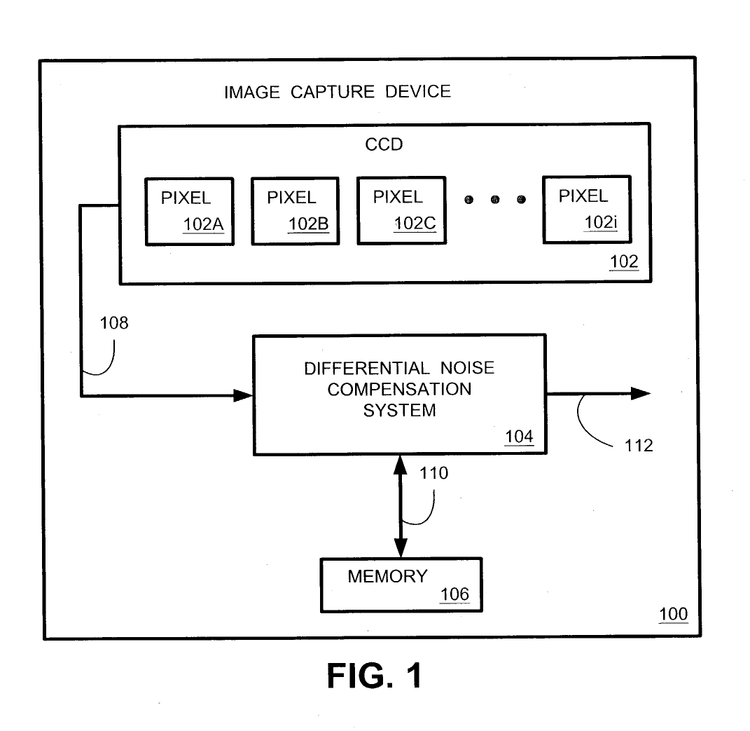

FIG. 1 is a block diagram illustrating an embodiment of an image capture device having a charge-coupled device (CCD) according to the present invention. CCD 102 comprises a plurality of pixels 102a-102i configured to detect light. CCD further includes a differential noise compensation system 104 and a memory 106. Light information is communicated from the pixels 102a-102i to the differential noise compensation system 104 via connection 108. The differential noise compensation system 104 determines a base DSNU offset and a base PRNU gain for light information associated with each pixel.

The differential noise compensation system 104 determines a differential DSNU compensating value by taking the difference between light information from the pixels 102a-102i and the base DSNU compensating value, and stores the base DSNU compensating value and the differential DSNU compensating value in the memory 106, via connection 110. The differential noise compensation system 104 also determines a differential PRNU compensating value by taking the difference between light information from the pixels and the base PRNU compensating value, and stores the base PRNU compensating value and the differential PRNU compensating value in the memory 106.

As an image is captured, pixels 102a-102i generate light information corresponding to the image and communicate the light information to differential noise compensation system 104. One embodiment of the differential noise compensation system 104 retrieves the base DSNU compensating value and the differential. DSNU compensating from the memory, adds the base DSNU compensating value and the differential DSNU compensating value to define a DSNU compensation value, and modifies the light information corresponding to the image by combining the DSNU compensation value with the light information from the pixel to compensate for DSNU noise.

Similarly, the differential noise compensation system 104 retrieves the base PRNU compensating value and the differential PRNU compensating from the memory, adds the base PRNU compensating value and the differential PRNU compensating value to define a PRNU compensation value, and modifies the light information corresponding to the image by multiplying the PRNU compensation value with the light information from the pixel to compensate for PRNU noise.

The modified light information is communicated, via connection 112, from the differential noise compensation system 104 out to other components (not shown) of the image capture device 100 so that a captured image is generated from the compensated light information. Accordingly, because the differential DSNU compensating values and the differential PRNU compensating values stored in memory 106 are smaller than the DSNU compensating values and the PRNU compensating values, respectively, the size of memory 106 used is reduced.

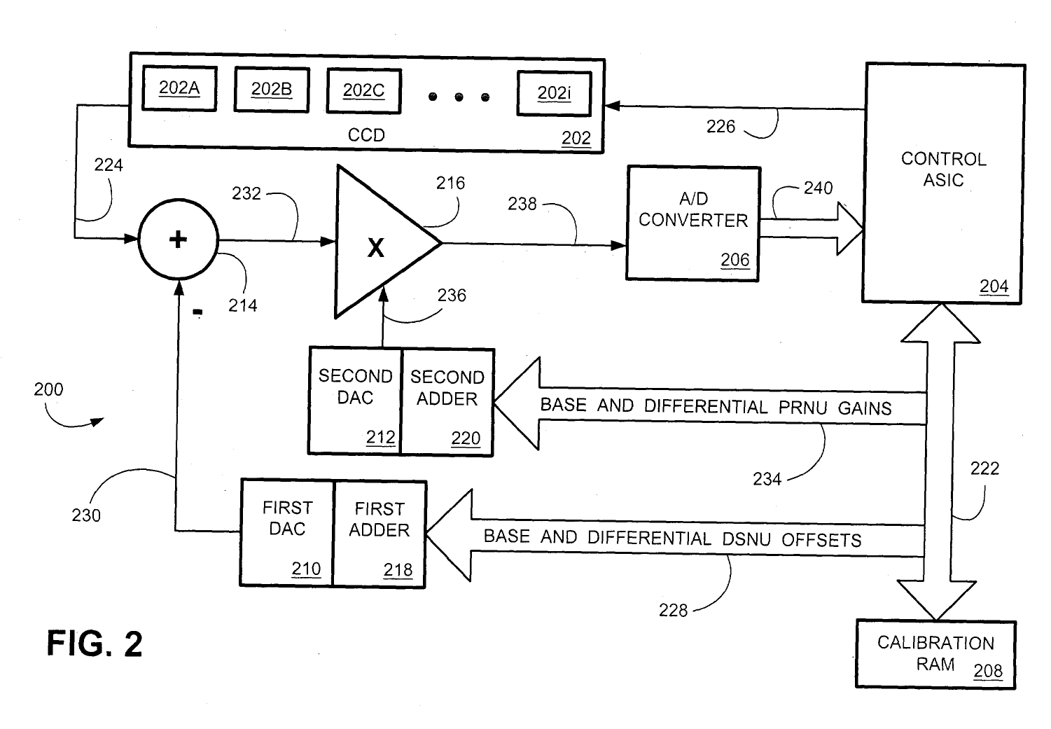

FIG. 2 is a block diagram illustrating an embodiment of an image capture device. Image capture device 200 comprises at least a charged coupling device (CCD) 202, a control application specific integrated circuit (ASIC) 204, an analog-to-digital (A/D) converter 206, a calibration random-access memory (RAM) 208, a first digital-to-analog converter (DAC) 210, a second DAC 212, a summer 214, a multiplier 216, a first adder 218 and a second adder 220. Any suitably configured processor (not shown), in other embodiments in accordance with the present invention, may be substituted for the control ASIC 204.

The control ASIC 204 provides suitable control signals to the CCD 202 such that light information is communicated through the adder 214, multiplier 216 and A/D converter 206 to the control ASIC 204. For convenience, a single CCD 202 is illustrated as a component block. The CCD 202 has at least an array of pixels 202a-202i. In one embodiment according to the present invention, CCD 202 comprises approximately 10,000 pixels. Other embodiments employ different suitable numbers of pixels, and or types of color-sensitive pixels, in the CCD 202.

Registers (not shown) are in communication with each pixel 202a-202i to collect charges, also referred to as light information, from each pixel 202a-202i. The CCD 202 also comprises components configured to communicate the collected light information from the pixels 202a-202i into the registers, and to communicate the light information from the registers to the connection 224.

Prior to collecting light information from the CCD 202, the image capture device 200 performs a dark signal calibration test. That is, test information is collected from each pixel 202a-202i when the pixels 202a-202i are not exposed to light. Thus, the test information is comprised of data corresponding to noise, such as but not limited to, thermal noise, is determined.

In one embodiment, during the start of the dark signal calibration test, charge information is collected from the first pixel 202a. Information corresponding to this change information is stored in the calibration RAM 208, via connection 222, as a binary number, a hexadecimal number or other suitable digital number. This information from the first pixel 202a is used as a base for referencing charges collected from the remaining pixels 202b-202i. In this embodiment, this information from the first pixel 202a is hereinafter referred to as the base dark signal non-uniformity (DSNU) offset. In this embodiment, ten bits of memory capacity in the calibration RAM 208 are allocated for storing the base DSNU offset. Other embodiments allocate other suitable values of memory capacity in the calibration RAM 208.

When the charge information from the second pixel 202b is received, the second pixel charge information is subtracted from the base DSNU offset to generate a differential DSNU offset. This differential DSNU offset is stored in the calibration RAM 208 and is associated with the second pixel 202b. In one embodiment, four bits of memory capacity in the calibration RAM 208 are allocated for storing the differential DSNU offset.

When change information is received from the third pixel 202c, the third pixel charge information is subtracted from the base DSNU offset to generate a differential DSNU offset. This differential DSNU offset is stored in the calibration RAM 208 and is associated with the third pixel 202c. Similarly, four bits of memory capacity in the calibration RAM 208 is allocated for storing this second differential DSNU offset.

The process of determining and storing a differential DSNU offset for each pixel in the CCD 202 is repeated as described above. Upon the completion of the dark signal calibration test, a base DSNU offset has been stored for the first pixel 202a and differential DSNU offsets have been calculated and stored for all of the other pixels 202b-202i of the CCD 202.

Since the differential DSNU offsets are smaller than the actual offsets themselves, the size of the calibration RAM 208 used is substantially smaller than the size of the calibration RAM 108 (FIG. 1). Accordingly, the total memory capacity allocated for the differential DSNU offsets (each four bits in one embodiment) for the pixels of the CCD 202 is smaller than the total memory capacity allocated for the DSNU offsets (ten bits each) of the linear CCD 102.

In one embodiment, the time period that the pixels 202a-202i accumulate charge during the dark signal calibration test equals the image scan exposure time. The image scan exposure time is the period of time that the pixels 202a-202i accumulate charge when an image is being scanned or captured. Since the amount of charge expected to be accumulated by any individual pixel during the dark signal calibration test is zero, any charge accumulated by the pixel during the dark signal calibration test is noise and should be subtracted out during the compensation process, described in greater detail below. Thus, the accumulated charge from the pixel is determined as a function of the base DSNU offset and the differential DSNU offset, as described above.

In another embodiment, the time period that the pixels 202a-202i accumulate charge during the dark signal calibration test is greater than the image scan exposure time. As an example, the time period that the pixels 202a-202i accumulate charge during the dark signal calibration test may be equal to ten times the image scan exposure time. Accordingly, a greater time period for the dark signal calibration test provides for more accumulation of charge from the noise, and thus greater noise sensitivity. Accordingly, information corresponding to the charge accumulated by a pixel is multiplied by the ratio between the image scan exposure time and the time of the dark signal calibration test. In the illustrative, non-limiting example above where the dark signal calibration test time is equal to ten times the image exposure time, information corresponding to the accumulated charge may be multiplied by a factor of 0.10 (one divided by ten) to determine an appropriate time-averaged DSNU offset.

In another embodiment, information for all of the pixels 202a-202i residing in the CCD 202 is communicated to the control ASIC 204. Information for one pixel is selected as the base DSNU offset. For example, the pixel having the greatest noise value, the least noise value, the medium noise value, or the average noise value may be selected as the base DSNU offset. Thus, the differential DSNU offsets determined for the other pixels may be a smaller value that might otherwise be determined by the above-described dark signal calibration test wherein the information from the first pixel 202a is used to determine the base DSNU offset.

Yet another embodiment employs a predetermined base DSNU offset. Such an offset may be predetermined based upon previously conducted dark signal calibration tests or upon design parameters. Such a base DSNU offset can be, permanently stored in the calibration RAM 208 or in another suitable memory medium. Accordingly, each one of the pixels 202a-202i are associated with a predefined base DSNU offset.

In the above-described embodiments, one dark signal calibration test is performed. Another embodiment conducts a plurality of dark signal calibration tests since a dark signal calibration test may be completed in a relatively short period of time. Information values corresponding to pixel charges received from each pixel 202a-202i are then averaged with charge information values for that same pixel from the other dark signal calibration tests prior to determining the base DSNU offset and the differential DSNU offsets. In another embodiment, the differential DSNU-U offsets are determined for a plurality of dark signal calibration tests. Then, the differential DSNU offsets for each pixel 202a-202i are averaged. Such an embodiment employing multiple dark signal calibration tests provides for greater compensation accuracy.

One embodiment performs the above-described dark signal calibration test before the capture of each image. Another embodiment performs the dark signal calibration test on a periodic basis. Yet another embodiment performs the dark signal calibration test only once during initialization. Consistent with the scope and spirit of the present invention, other embodiments may perform the dark signal calibration test at other times.

Prior to capturing an image, the image capture device 200 performs a light signal calibration test. In the light signal calibration test, a light source (not shown) illuminates a white image or other suitable reference image. Charge is accumulated by the pixels 202a-202i. This test information is then communicated from the CCD 202. Due to the above-described noise associated with a pixel when the pixel is detecting light, due in part to non-uniformity between the pixels 202a-202i and to non-uniformity in light from the light source, the light information collected by the pixels 202a-202i varies from pixel to pixel.

The light signal calibration test may be performed in a variety of manners. One embodiment communicates the light information for all pixels in the CCD 202. The pixel collecting the greatest charge is identified and defined as a reference pixel. The light information for this reference pixel is defined as 1.0 per unit or another suitable reference value. The light information from the other pixels are normalized to the reference pixel light information value. For example, one of the pixels may have a normalized value of 90%. That is, the value of the light information from the pixel equals 90% of the value of the light information from the reference pixel.

Since, under a uniform color and light condition, all pixels 202a-202i should ideally have the same light information value, the normalized value for the pixels are used to determine a compensation factor for each pixel 202a-202i, referred to as a photo response non-uniformity (PRNU) gain. To compensate light information for the pixels 202a-202i in the CCD 202, the light information received from each pixel is multiplied by the PRNU gain. As described in greater detail below, the PRNU gain according to the present invention equals a base PRNU gain plus a differential PRNU gain. In the above-described example where the normalized value for the pixel was 90%, the PRNU gain equals the inverse of the normalized value (1.111, rounded to three significant digits). Thus, light information received from each pixel 202a-202i is multiplied by its respective PRNU gain, and thereby is compensated to correspond to the light information associated with the reference pixel.

Another embodiment defines the reference PRNU gain as a predefined value of light information from the selected reference pixel. For example, the reference light information value may be defined as 90% of the light value received from the reference pixel or another selected pixel. Light information for the reference pixel and the other pixels are normalized to this reference light information value. These normalized values are used to determine the differential PRNU gain.

When the light signal calibration test is performed by image capture device 200, one embodiment according to the present invention employs a light source having an adjustable intensity. Accordingly, the light intensity is adjusted to a desired level during the light signal calibration test such that a predetermined light intensity is provided to the pixels. For example, the light value in one embodiment is adjusted such that the reference pixel is charging to 90% of the maximum charge capacity of the pixel. Another embodiment employs a light having a single intensity that is used both for scanning an image and for performing the light signal calibration test. Yet another embodiment according to the present invention employs a plurality of light sources such that selected light sources provide a first light intensity for the light signal calibration test and another light intensity for capturing images.

According to the present invention, one embodiment stores the reference light information value associated with the reference pixel into the calibration RAM 208 as a binary number, a hexadecimal number or other suitable digital number. The differential PRNU gains for the pixels 202a-202i are determined by subtracting the normalized PRNU gain from the base PRNU gain for each pixel 202a-202i. These differential PRNU gains are stored into the calibration RAM 208. In one embodiment, ten bits of memory storage capacity are allocated to the base PRNU gain, and only four bits are allocated for each of the differential PRNU gains. Since the differential PRNU gains are smaller then the actual gains themselves, the size of the calibration RAM 208 used is substantially smaller than the size of the calibration RAM 108 (FIG. 1). Accordingly, the total memory capacity allocated for the differential PRNU gains (each four bits in one embodiment) is smaller than the total memory capacity allocated for the PRNU gains (ten bits each) for each pixel stored in the CCD 202.

In the above-described embodiments, one light signal calibration test is performed. Another embodiment conducts a plurality of light signal calibration tests since a light signal calibration test may be completed in a relatively short period of time. Light information values received from each pixel 202a-202i are averaged with light information values for that same pixel from the other light signal calibration tests, in one embodiment, prior to determining the base PRNU gain and the differential PRNU gains. In another embodiment, the base PRNU gain and the differential PRNU gains are determined for each one of the light signal calibration tests, and then the respective base PRNU gain and the differential PRNU gains for each pixel 202a-202i are averaged. Such an embodiment employing multiple light signal calibration tests provides for greater compensation accuracy.

One embodiment performs the above-described light signal calibration test before the capture of each image. Another embodiment performs the light signal calibration test on a periodic basis or only once during initialization of the image capture device 200. Consistent with the scope and spirit of the present invention, other embodiments may perform the light signal calibration test at other times.

After completion of the dark signal calibration tests and/or the light signal calibration tests, image capture device 200 captures or scans a portion of an image such that light information associated with the image portion is captured by the plurality of pixels residing in the CCD 202. After the capturing of an image portion or the scanning of the image portion is completed, control ASIC 204 communicates a suitable control signal, via connection 226, to the CCD 202, such that the light information from each pixel 202a-202i is communicated serially over the connection 224. As light information from each pixel 202a-202i is serially communicated into the adder 214, the image capture device 200 modifies the light information from the pixels 202a-202i based upon the base DSNU offset and the differential DSNU offset associated with each pixel. This process is referred to as DSNU compensation.

DSNU compensation begins by the control ASIC 204 communicating a suitable instruction to the calibration RAM 208 such that the base DSNU offset and the differential DSNU offset are communicated to the first adder 218 for the first pixel 202a, via connections 222 and 228. The first adder 218 adds the base DSNU offset and the differential DSNU offset corresponding to the first pixel 202a. The added base DSNU offset and the differential DSNU offset for each pixel is hereinafter referred to as the DSNU compensating offset value.

The DSNU compensating offset value for the first pixel 202a is a suitable digital value that is communicated from the first adder 218 to the first DAC 210. The first DAC 210 converts the DSNU compensating offset value for the first pixel 202a into a suitable analog signal and communicates the analog signal to the adder 214, via connection 230. As light information from the first pixel 202a is communicated to the adder 214, or another suitable combining element, the DSNU compensating offset value offset is subtracted from the light information, thereby compensating light information from the first pixel 202a for DSNU noise.

This DSNU compensated light information from the first pixel 202a is then communicated to the multiplier 216, via connection 232. The light information is then modified based upon the PRNU gain and the differential PRNU gain associated with each pixel. This process is referred to as PRNU compensation. PRNU compensation, according to the present invention, is performed by the multiplier 216 as described below.

Control ASIC 204 communicates a suitable instruction to the calibration RAM 208 such that the base PRNU gain and the differential PRNU gain is, communicated to the second adder 220 for the first pixel 202a, via connections 222 and 234. The second adder 220 adds the base PRNU gain and the differential PRNU gain corresponding to the first pixel 202a. The added base PRNU gain and the differential PRNU gain for each pixel is hereinafter referred to as the PRNU compensating gain value.

The PRNU compensating gain value for the first pixel 202a, which is a suitable digital value, is communicated from the second adder 220 to the second DAC 212. The second DAC 212 converts the PRNU compensating gain value for the first pixel 202a into a suitable analog signal and communicates the analog signal to the multiplier 216, via connection 236. As light information from the first pixel 202a is communicated to the multiplier 216, or another suitable combining element, the PRNU compensating gain value is multiplied with the light information, thereby compensating light information from the first pixel 202a for PRNU noise.

After the light information from the first pixel 202a is compensated for both DSNU noise and PRNU noise, in accordance with the present invention as described above, the compensated light information is communicated from the multiplier 216 to the A/D converter 206, via connection 238. A/D converter 206 converts the received light information associated with the first pixel 202a into a suitable digital signal, and communicates the digitized light information associated with the first pixel 202a to the control ASIC 204, via connection 240.

Light information from subsequent pixels 202b-202i is similarly compensated as described above. Thus, light information for each pixel 202a-202i is compensated for both DSNU noise and PRNU noise in accordance with the present invention. As the remaining portions of the image are scanned, light information for each pixel 202a-202i is compensated for both DSNU noise and PRNU noise in accordance with the present invention. Accordingly, compensated light information from the pixels 202a-202i residing in the CCD 202 is further processed such that the image is captured by the image capture device 200.

The above embodiments are described as performing both DSNU compensation and PRNU compensation in accordance with certain embodiments of the present invention. Alternative embodiments of the present invention perform only one of the above-described compensations to the received light information, either DSNU compensation or PRNU compensation. Accordingly, such an embodiment is derived from FIG. 2 by removing the above-described compensation circuitry that is not employed. For example, if the PRNU compensation is not performed, the second DAC 212, second adder 220, multiplier 216, connection 232 and connection 234 are omitted such that only the DSNU compensated light information is communicated directly to the A/D converter 206, via connection 230 and 236.

For convenience of explaining certain inventive features, the components of image capture device 200 were described and illustrated as separate components and connections. One embodiment of image capture device 200 may be fabricated using separate components. Other embodiments of image capture device 200 may fabricate selected ones of the above-described components onto a single substrate, onto a single chip, or onto a single unit. For example, one embodiment of image capture device 200 implements the present invention entirely in firmware by fabricating the control ASIC 204, the A/D converter 206, the calibration RAM 208, the first DAC 210, the second DAC 212, the summer 214, the multiplier 216, the first adder 218, the second adder 220 and connections 228, 230, 232, 234, 236, 238 and 240 onto a single chip. Such embodiments are advantageous in minimizing the number of connection pins, thereby facilitating the manufacturing process of image capture device 200 and thereby reducing the size of the image capture device.

Furthermore, the control ASIC 204 may be implemented as firmware, or a combination of hardware and firmware. When implemented as hardware, control ASIC 204 is constructed with hardware components now known or later developed. For example, one embodiment of the present invention implements above-described selected components as a state machine having a suitable configuration of transistors on an integrated circuit (IC) chip. Accordingly, many suitable alternative configurations of the transistors (not shown) residing in a control IC chip may be implemented having the above-described functionality and operation, and that such embodiments can be readily implemented by one of ordinary skill in the art after having become familiar with the teachings of the present invention.

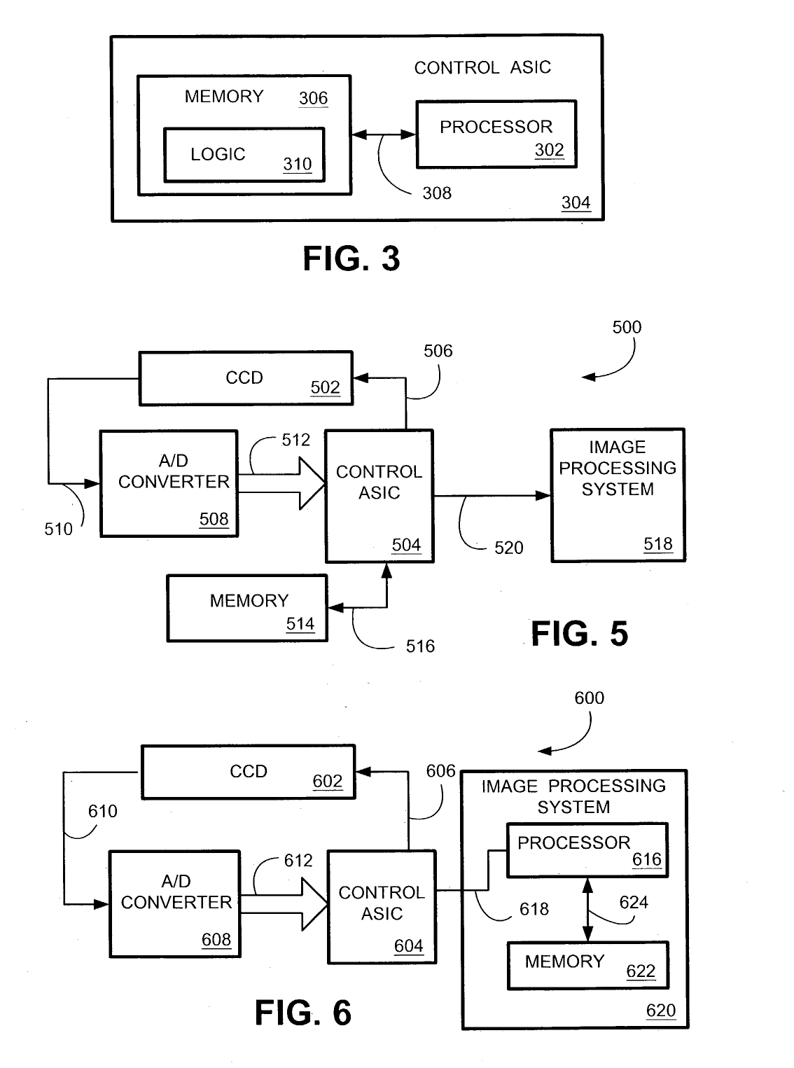

FIG. 3 is a block diagram illustrating an embodiment of a control ASIC. This embodiment is implemented as a combination of hardware, software and/or firmware. Control ASIC 304 comprises at least a processor 302. Processor 302 communicates with memory 306, via connection 308: Logic 310 resides in memory 306 and is retrieved and executed by the processor 302 such that the base DSNU offset, the differential DSNU offsets, the base PRNU gain and the differential PRNU gains are determined and saved into the calibration RAM 208 (FIG. 2), as described above.

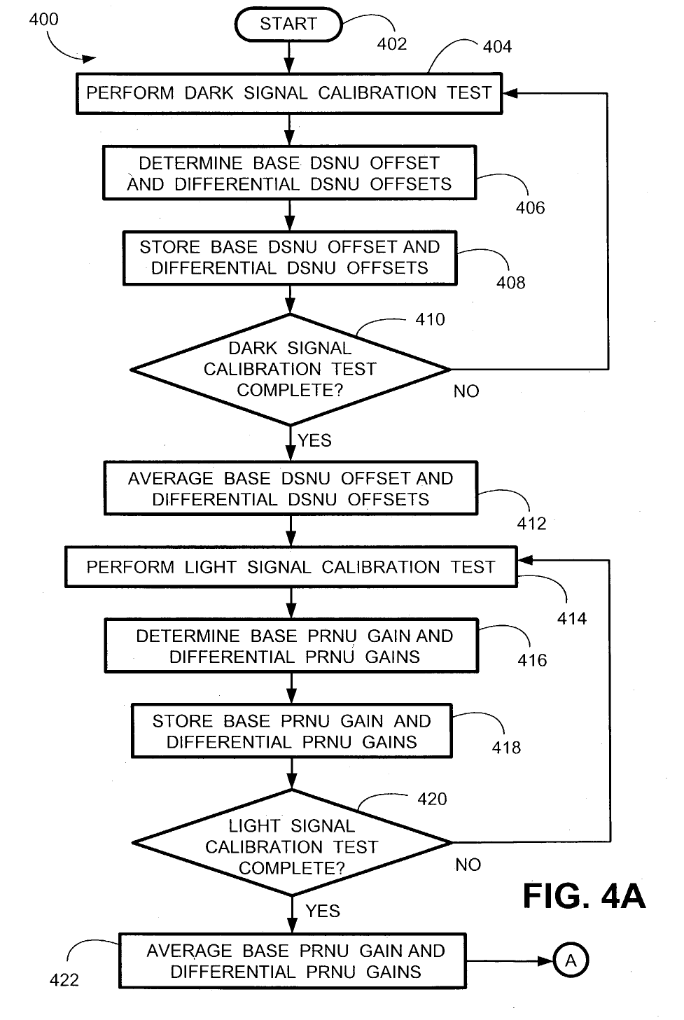

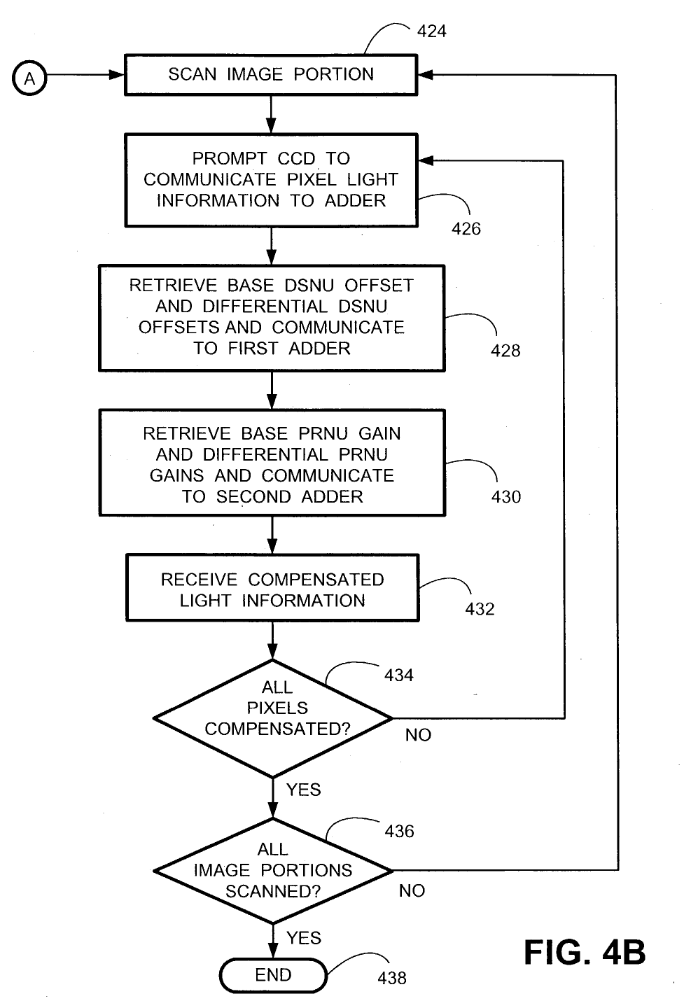

FIGS. 4A and 4B show a flow chart illustrating a process, according to the present invention, for compensating dark signal non-uniformity (DSNU-U) noise and photo response non-uniformity (PRNU) noise in the image. The flow chart 400 of FIGS. 4A and 4B shows the architecture, functionality, and operation of an embodiment for implementing the logic 310 (FIG. 3) such that the base DSNU offset, the differential DSNU offsets, the base PRNU gain and the differential PRNU gains are determined and saved into the calibration RAM 208 (FIG. 2), as described above in accordance with the present invention. An alternative embodiment implements the logic of flow chart 400 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIGS. 4A and 4B, or may include additional functions, without departing from the functionality of the image capture device 200. For example, two blocks shown in succession in FIGS. 4A and 4B may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention.

The process begins at block 402. At block 404, image capture device 200 (FIG. 2) according to the present invention, performs a dark signal calibration test, described in greater detail above. At block 406, light information received from the pixels 202a-202i residing in the CCD 202 is processed on a pixel-by-pixel basis to determine a base DSNU offset and differential DSNU offsets for each of the pixels 202a-202i. At block 408, the determined base DSNU offset and the differential DSNU offsets for each of the pixels are saved in one embodiment into the calibration RAM 208 or another suitable memory unit.

At block 410, a determination is made whether the dark signal calibration testing is complete. If additional dark signal calibration tests are to be performed (the NO condition), the process returns to block 404 such that the next dark signal calibration test is performed. However, if at block 410 no additional dark signal calibration tests are to be performed (the YES condition), the process proceeds to block 412. At block 412, in embodiments performing multiple dark signal calibration tests, the average base DSNU offsets and the differential DSNU offsets for each pixel are averaged.

In an alternative embodiment, an average rolling process is employed wherein the base DSNU offsets and the differential DSNU offsets are predivided by the number of dark signal calibration tests and accumulated into a register or another suitable memory unit. Accordingly, block 412 would be replaced with another block immediately preceding block 410.

At block 414, image capture device 200 performs the above-described light signal calibration test. At block 416, the base PRNU gain and the differential PRNU gains for the pixels 202a-202i are determined on a pixel-by-pixel basis. At block 418, the base PRNU gain and the differential PRNU gains are saved to the calibration RAM 208. At block 420, a determination is made whether additional light signal calibration tests are to be performed. If additional light signal calibration tests are to be performed (the NO condition), the process proceeds back to block 414 such that another light signal calibration test is performed. If at block 420 no additional light signal calibration tests are to be performed (the YES condition), the process proceeds to block 422. At block 422, in embodiments performing multiple light signal calibration tests, the average base PRNU gain and the differential PRNU gains for each pixel are averaged.

In an alternative embodiment, an average rolling process is employed wherein the base PRNU gains and the differential PRNU gains are predivided by the number of light signal calibration tests and accumulated into a register or another, suitable memory unit. Accordingly, block 422 would be replaced with another block immediately preceding block 420.

At block 424, the image capture device 200 scans a portion of the image. At block 426, the CCD 202 is prompted to communicate the light information from the pixels 202a-202i on a pixel-by-pixel basis to the adder 214. At block 428, the base DSNU offset and the differential DSNU offsets are retrieved from the calibration RAM 208 on a corresponding pixel-by-pixel basis and communicated to the first adder 218. Accordingly, the base DSNU offset and the differential DSNU offsets are processed by the first adder 218 and the first DAC 210 on a pixel-by-pixel basis, as described above, and communicated to the adder 214 such that the light information from the pixels 202a-202i is compensated for DSNU noise.

At block 430, the base PRNU gain and the differential PRNU gains are retrieved from the calibration RAM 208 and communicated to the second adder 220 on a pixel-by-pixel basis. Accordingly, the second adder 220 and the second DAC 212 process the base PRNU and the differential PRNU gains, as described above, and communicates the gains to multiplier 216 such that the light information is compensated for PRNU noise on a pixel-by-pixel basis.

At block 432, the control ASIC 204 receives the compensated light information from the A/D converter 206 on a pixel-by-pixel basis, as described in detail above. At block 434, a determination is made whether all pixels have been compensated in accordance with the above-described process that compensates light information on a pixel-by-pixel basis. If light information from all of the pixels have been compensated (the YES condition), the process proceeds to block 436. If not (the NO condition), the process returns to block 426 such that the remaining pixels are compensated on a pixel-by-pixel basis.

At block 436, a determination is made whether all image portions have been scanned. If additional image portions are to be scanned (the NO condition), the process returns to block 424 such that the next image portion is scanned. If all image portions have been scanned (the YES condition), the process proceeds to block 438 and ends.

Another embodiment of image capture device 200, according to the present invention, is configured with a plurality of linear CCDs. For example, pixels in a linear CCD may be configured to be color-sensitive. Thus, color scanning is provided by providing color-sensitive pixels sensitive to a selected color, such as, but not limited to, red, green and/or blue. Other suitable colors may be employed. Another embodiment may comprise pixels sensitive to white light, thus providing for the scanning of black-and-white images, such as, but not limited to, text.

In an alternative embodiment, according to the present invention, employing a plurality of linear CCDs, the image capture device 200 employs an adder and a multiplier for each linear CCD. Thus, light information from each linear CCD is compensated by subtracting the DSNU compensating offset value for each pixel 202a-202i, and by multiplying by the PRNU compensating gain value for each pixel 202a-202i. A single control ASIC may be used to control the plurality of linear CCDs and other components according to the present invention. Alternatively, one control ASIC may be used to control each one of the plurality of linear CCDs and other components according to the present invention.

Similarly, one calibration RAM may be used for storing all of the base DSNU offset, the differential DSNU offsets, the base PRNU gain and the differential PRNU gains for the plurality of linear CCDs. Alternatively, individual calibration RAMs may be employed for each one of the plurality of linear CCDs.

In an alternative embodiment according to the present invention, a matrix-type CCD is employed. The matrix CCD, also referred to as an area CCD, may be relatively small. For example, a matrix CCD may have only four color-sensitive rows of pixels (red, green, blue, black/white). Such an embodiment may be utilized in a color scanner-type device. Such an embodiment stores the base DSNU offset, the differential DSNU offsets, the base PRNU gain and the differential PRNU gains for the plurality of pixels in a calibration RAM or in another suitable storage medium, as described above. When the image is scanned by the matrix CCD, light information from each pixel is compensated for according to the present invention.

Alternatively, the matrix CCD may be a relatively large array of pixels. For example, an array of over three million pixels is found in some embodiments of digital image capture devices, such as, but not limited to, a digital camera. Such digital cameras, depending upon the configuration, capture still and/or video images. Thus, when the image is captured by the matrix CCD, light information from each pixel is compensated for according to the present invention. , One embodiment employs a single adder and a single multiplier, thereby compensating the light information in accordance with the present invention. Another embodiment partitions the matrix CCD into a plurality of suitable smaller regions and employs a plurality of adders and a plurality of multipliers to compensate the light information, thereby speeding up the compensation process according to the present invention. Multiple control ASICs may also be employed in such an embodiment.

FIG. 5 is a block diagram illustrating an alternative embodiment of an image capture device. The image capture device 500 is configured to digitally compensate light information from the pixels (not shown) residing in the CCD 502. CCD 502 may be a single linear CCD, a plurality of linear CCDs, or a matrix CCD, as described herein. Control ASIC 504 communicates a suitable control signal, via connection 506, to the CCD 502, thereby prompting the CCD 502 to communicate light charges from the pixels to the A/D converter 508, via connection 510. The light charges from the pixels are converted to digitized light information by the A/D converter 508. The light information is communicated to the control ASIC 504, via connection 512.

When a dark signal calibration test is performed, the received light information is used by the control ASIC 504 to determine the above-described base DSNU offset and the differential DSNU offsets, in accordance with the present invention. The base DSNU offset and the differential DSNU offsets are stored into the memory 514, via connection 516. Similarly, when a light signal calibration test is performed, the received light information is used by the control ASIC 504 to determine the above-described base PRNU gain and the differential PRNU gains, in accordance with the present invention. The base PRNU gain and the differential PRNU gains are stored into the memory 514.

When the image capture device 500 captures an image, light information corresponding to the captured image is communicated to the control ASIC 504. Control ASIC 504 retrieves the base DSNU offset, the differential DSNU offsets, the base PRNU gain and the differential PRNU gains such that the ASIC 504 digitally compensates the light information for DSNU noise and PRNU noise in accordance with the present invention. To digitally compensate for the DSNU noise, the control ASIC 504 adds the base DSNU offset and the differential DSNU offset to determine a DSNU compensating offset value for each pixel, and digitally subtracts the DSNU compensating offset value from the incoming light information. To digitally compensate for the PRNU noise, the control ASIC 504 adds the base PRNU gain and the differential PRNU gain to determine a PRNU compensating gain value for each pixel, and digitally multiplies the PRNU compensating gain value to the incoming light information. The compensated light information is then communicated to the image processing system 518, via connection 520, for additional processing.

Another embodiment, also represented by FIG. 5, the dark signal calibration test and the light signal calibration test are performed as described above to digitally determine the base DSNU offset, the differential DSNU offsets, the base PRNU gain and the differential PRNU gains, in accordance with the present invention. The base DSNU offset, the differential DSNU offsets, the base PRNU gain and the differential PRNU gains are stored into the memory 514.

When the image capture device 500 captures an image, light information corresponding to the captured image is communicated to the control ASIC 504. Instructions, communicated to the control ASIC 504, cause the control ASIC 504 to retrieve and add the base DSNU offset to the differential DSNU offsets, thereby determining a DSNU compensating offset value for each pixel. Also, the control ASIC 504 retrieves and adds the base PRNU gain and the differential PRNU gains, thereby determining a PRNU compensating gain value for each pixel.

To compensate for DSNU noise, the control ASIC 504 communicates the DSNU compensating offset values directly to a first DAC 210 (FIG. 2). Thus, with this embodiment, first adder 218 is not employed. The first DAC 210 communicates an analog signal corresponding to the DSNU compensating offset values to an adder 214 such that light information is compensated according to the present invention.

To compensate for PRNU noise, instructions cause the control ASIC 504 to communicate the PRNU compensating gain values directly to a second DAC 212 (FIG. 2). Thus, with this embodiment, second adder 218 is not employed. The second DAC 212 communicates an analog signal corresponding to the PRNU compensating gain values to a multiplier 216 such that light information is compensated according to the present invention.

FIG. 6 is a block diagram illustrating an alternative embodiment of an image capture device. The image capture device 600 is configured to digitally compensate light information for the pixels (not shown) residing in the CCD 602. CCD 602 may be a single linear CCD, a plurality of linear CCDs, or a matrix CCD, as described herein. Control ASIC 604 communicates a suitable control signal, via connection 606, to the CCD 602, thereby prompting the CCD 602 to communicate light charges from the pixels to the A/D converter 608, via connection 610. The light charges from the pixels are converted to digitized light information by the A/D converter 608. The light information is communicated to the control ASIC 604, via connection 612. Then, the light information is communicated to a processor 616, via connection 618, residing in an image processing system 620.

When a dark signal calibration test is performed, the received light information is processed by the processor 616 to determine the above-described base DSNU offset and the differential DSNU offsets, in accordance with the present invention. The base DSNU offset and the differential DSNU offsets are stored into the memory 622, via connection 624. Similarly, when a light signal calibration test is performed, the received light information is processed by the processor 616 to determine the above-described base PRNU gain and the differential PRNU gains, in accordance with the present invention. The base PRNU gain and the differential PRNU gains are stored into the memory 622.

When the image capture device 600 captures an image, light information corresponding to the captured image is communicated to the control ASIC 604. Control ASIC 604 communicates the light information to the processor 616. Processor 616 retrieves the base DSNU offset, the differential DSNU offsets, the base PRNU gain and the differential PRNU gains in accordance with the present invention. To digitally compensate for the DSNU noise, the processor 616 adds the base DSNU offset and the differential DSNU offset to determine a DSNU compensating offset value for each pixel, and digitally subtracts the DSNU compensating offset value from the incoming light information. To digitally compensate for the PRNU noise, the processor 616 adds the base PRNU gain and the differential PRNU gain to determine a PRNU compensating gain value for each pixel, and digitally multiplies the PRNU compensating gain value to the incoming light information.

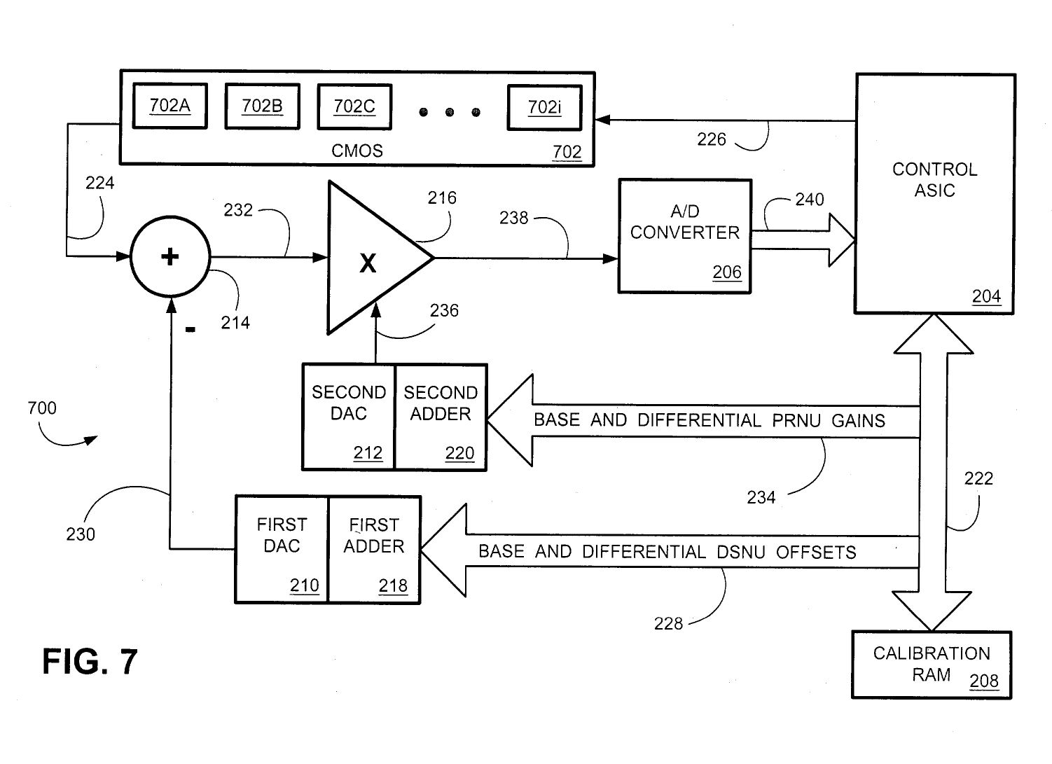

FIG. 7 is a block diagram illustrating an another embodiment of an image capture device employing a complimentary metal oxide semiconductor (CMOS) device. CMOS 702 comprises a plurality of pixels 702a-702i. CMOS 702 comprises other components, not shown for convenience, that are configured such that CMOS 702 communicates light information corresponding to light sensed by the pixels 702a-702i onto connection 224. The image capture device 700 employing CMOS 702, according to the present invention, is configured with components that are similar, or the same, as the components described above for the image capture device 200. For convenience, similar or like components in FIGS. 2 and 7 bear like reference numerals and are not described again. Accordingly, the image capture device 700 employing CMOS 702 compensates light information from the pixels 702a-702i for DSNU noise and/or PRNU noise in accordance with any of the above-described embodiments of the present invention employing pixels in a CCD.

Pixels 702a-702i in one embodiment are configured into a single linear CMOS array for scanning. Alternatively, the pixels 702a-702i in another embodiment are configured into a plurality of CMOS linear arrays for color and/or black-and-white scanning. In yet another embodiment, the pixels 702a-702i are configured into a matrix CMOS for use in a digital camera or the like.

Alternative embodiments employing CMOS linear arrays are implemented in accordance with any of the above-described architectures of FIGS. 2, 3, 5 and/or 6. Furthermore, alternative embodiments employing CMOS technology are also implemented in accordance with the other alternative embodiments of the present invention as described herein. That is, DSNU noise and PRNU noise is compensated in an image capture device employing CMOS technology with any of the embodiments described herein in accordance with the present invention.

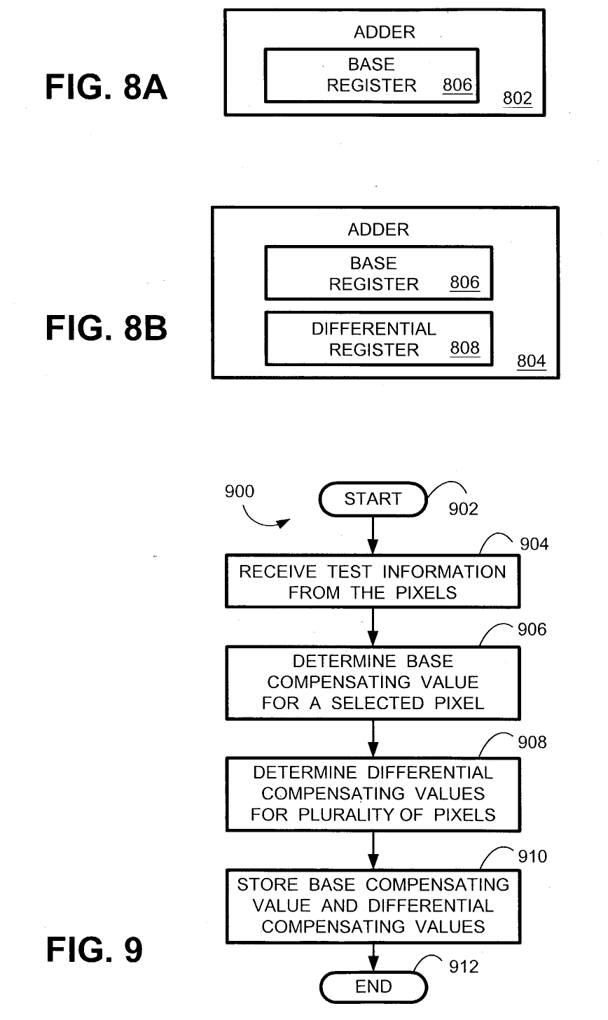

FIGS. 8A and 8B are block diagrams illustrating alternative embodiments of an image capture device employing adders having at least one register. Adder 802 employs a base register 806 configured to receive and store a base value for each pixel. Other embodiments employ a suitable memory configured to receive and store the base value. For example, if the adder 802 is implemented in the first adder 218, the base register 806 is configured to receive and store the base DSNU offset. Similarly, if the adder 802 is implemented in the second adder 220, the base register 806 is configured to receive and store the base PRNU gain. Accordingly, the calibration RAM 208 is not used to store the base DSNU offset and/or the base PRNU gain, thereby further reducing the required capacity of the calibration RAM 208 and the bandwidth of related system components.

Thus, when light information from a pixel is compensated for DSNU noise, the differential DSNU offset is communicated from the calibration RAM 208 to an adder 802, and the base DSNU offset residing in the base register 806 is added to the received differential DSNU offset. Similarly, when light information from a pixel is compensated for PRNU noise, the differential PRNU gain is communicated from the calibration RAM 208 to an adder 802, and the base PRNU gain residing in the base register 806 is added to the received differential PRNU gain.

Another embodiment is implemented in accordance with any of the above-described architectures of FIGS. 2, 3, 5, 6 and/or 7 by determining the differential DSNU offsets and the differential PRNU gains from the value of the immediately preceding DSNU offset and the PRNU gain, respectively. Accordingly, the base DSNU offset and the base PRNU gain is the value of the DSNU offset and the PRNU gain of the immediately preceding pixel.

When the DSNU offset and the PRNU gain of the immediately preceding pixel are used as base values, the DSNU offset and the PRNU gain of the first pixel is stored in the calibration RAM 208 (or in another designated storage medium) during the dark signal calibration test and the light signal calibration test, respectively.

As the DSNU offset of the second pixel is received, the differential DSNU offset for the second pixel is determined by computing the difference between the DSNU offset of the first pixel and the second pixel. As the PRNU gain of the second pixel is received, the differential PRNU gain for the second pixel is determined by computing the difference between the PRNU gain of the first pixel and the second pixel. The determined differential DSNU offset and the differential PRNU gain for the second pixel is stored in calibration RAM 208 (or in another designated storage medium).

As the DSNU offset of the third pixel is received, the differential DSNU offset for the third pixel is determined by computing the difference between the DSNU offset of the second pixel and the third pixel. As the PRNU gain of the third pixel is received, the differential PRNU gain for the third pixel is determined by computing the difference between the PRNU gain of the second pixel and the third pixel. The determined differential DSNU offset and the differential PRNU gain for the third pixel is stored in calibration RAM 208 (or in another designated storage medium). Accordingly, the above-described process is repeated for all pixels such that differential DSNU offsets and the differential PRNU gains for all of the pixels are determined and stored in calibration RAM 208 (or in another designated storage medium).

As an image is captured, the base DSNU offset and the base PRNU gain for the first pixel is retrieved from calibration RAM 208 (or from another designated storage medium). The base DSNU offset and the base PRNU gain for the first pixel are used to compensate light information from the first pixel using any of the above-described embodiments.

When light information for the second pixel is compensated, the differential DSNU offset and the differential PRNU gain for the second pixel are retrieved from calibration RAM 208 (or from another designated storage medium). The base DSNU offset and the base PRNU gain (from the first pixel) are added to the retrieved differential DSNU offset and the differential PRNU gain for the second pixel, respectively. Accordingly, light information from the second pixel is compensated using any of the above-described embodiments. Furthermore, the determined DSNU offset and the PRNU gain for the second pixel is now the current base DSNU offset and the current base PRNU gain.

When light information for the third pixel is compensated, the differential DSNU offset and the differential PRNU gain for the third pixel are retrieved from calibration RAM 208 (or from another designated storage medium). The base DSNU offset and the base PRNU gain (from the second pixel) are added to the retrieved differential DSNU offset and the differential PRNU gain for the third pixel, respectively. Accordingly, light information from the third pixel is compensated using any of the above-described embodiments. Furthermore, the determined DSNU offset and the PRNU gain for the third pixel is now the current base DSNU offset and the current base PRNU gain used for compensating light information for the fourth pixel.

The above-described process is repeated for all pixels such that DSNU offsets and the PRNU gains for all of the pixels are determined by retrieving the differential DSNU offset and the differential PRNU gain for each pixel from the calibration RAM 208 (or from another designated storage medium), and by adding the current base DSNU offset and the current base PRNU gain (determined from the immediately preceding pixel) with the retrieved differential DSNU offset and differential PRNU gain. Accordingly, light information is compensated with the determined DSNU offsets and the PRNU gains using any of the above-described embodiments.

FIG. 8B illustrates an embodiment of an image capture device according to the present invention employing adder 804 having a base register 806 and a differential register 808. Base register 806 configured to receive and store a base value for each pixel. Other embodiments employ a suitable memory configured to receive and store the base value. For example, if the adder 804 is implemented in the first adder 218, the base register 806 is configured to receive and store the base DSNU offset. Similarly, if the adder 804 is implemented in the second adder 220, the base register 806 is configured to receive and store the base PRNU gain. Accordingly, the calibration RAM 208 is not used to store the base DSNU offset and/or the base PRNU gain, thereby further reducing the required capacity of the calibration RAM 208 and the bandwidth of related system components.

The differential register 808 is configured to receive and store a differential value for each pixel. For example, if the adder 804 is implemented in the first adder 218, the differential register 808 is configured to receive and store the differential DSNU offset. Similarly, if the adder 804 is implemented in the second adder 220, the differential register 808 is configured to receive and store the differential PRNU gain. Other embodiments employ a suitable memory configured to receive and store the differential value.

Thus, when light information from a pixel is compensated for DSNU noise, the differential DSNU offset is communicated from the calibration RAM 208 to a differential register 808, and the base DSNU offset residing in the base register 806 is added to the received differential DSNU offset. The added base DSNU offset and the differential DSNU offset is communicated to the DAC for compensating light information as described above. Furthermore, the added base DSNU offset and the differential DSNU offset is stored back into the base register 806, thereby generating a current base DSNU offset, as described above.

Similarly, when light information from a pixel is compensated for PRNU noise, the differential PRNU gain is communicated from the calibration RAM 208 to a differential register 208, and the base PRNU gain residing in the base register 806 is added to the received differential PRNU gain. The added base PRNU gain and the differential PRNU gain is communicated to the DAC for compensating light information as described above. Furthermore, the added base PRNU gain and the differential PRNU gain is stored back into the base register 806, thereby generating a current base PRNU gain, as described above.

Another embodiment implements the base register 806 in adder 802 (FIG. 8A) as an accumulating register. Thus, as a differential DSNU offset or a differential PRNU gain for a pixel is received by the adder 802, the differential DSNU offset or a differential PRNU gain is added to the current base DSNU offset or the base PRNU gain to determine the DSNU offset or a PRNU gain for that pixel. Then, as the differential DSNU offset or a differential PRNU gain for the next pixel received by the adder 802, the differential DSNU offset or a differential PRNU gain is added to the current base DSNU offset or the base PRNU gain to determine the DSNU offset or a PRNU gain for that next pixel. The process proceeds as described above for all of the pixels.

FIG. 9 shows a flow chart illustrating a process, according to an embodiment of the present invention, for compensating noise in an image. The flow chart 900 shows the architecture, functionality, and operation of an embodiment for implementing the logic 310 (FIG. 3), such as in a computer-readable medium implemented as a program, such that the base DSNU offset, the differential DSNU offsets, the base PRNU gain and the differential PRNU gains are determined and saved into the calibration RAM 208 (FIG. 2), as described above in accordance with the present invention. An alternative embodiment implements the logic of flow chart 900 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIGS. 9, or may include additional functions, without departing from the functionality of the image capture device 200. For example, two blocks shown in succession in FIG. 9 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention.

The process starts at block 902. At block 904, test information from a plurality of pixels is received. At block 906, a base compensating value corresponding to the test information from a selected one of the plurality of pixels is determined. At block 908, a plurality of differential compensating values is generated (or determined), each differential compensating value equal to a difference between the test information from each of the corresponding pixels and the base compensating value. At block 910, the base compensating value and the differential compensating values are stored into a memory. The process ends at block 912.

The above-described calibration RAM 208 is configured to store digital information corresponding to the determined base DSNU offset, the differential DSNU offsets, the base PRNU gain and the differential PRNU gains. Calibration RAM 208 may be any suitable computer-readable medium for use by or in connection with any state machine, control ASIC, computer and/or processor related system or method. In the context of this document, calibration RAM 208 is a computer-readable medium that is an electronic, magnetic, optical, or another physical device or means that contains or stores data. Furthermore, calibration RAM 208 can be embodied in any suitable computer-readable medium for use by or in connection with an instruction execution system, apparatus, or device, such as a computer-based system, processor-containing system, or other system that can fetch the instructions from the instruction execution system, apparatus, or device and execute the instructions associated with the determined base DSNU offset, the differential DSNU offsets, the base PRNU gain and the differential PRNU gains. In the context of this specification, a “computer-readable medium” can be any means that can store, communicate, propagate, or transport the data associated with, used by or in connection with the instruction execution system, apparatus, and/or device. The computer-readable medium can be, for example, an electronic, magnetic, optical, electromagnetic, infrared, or semiconductor system, apparatus, device, or propagation medium or other such medium now known or later developed.

When the present invention executes logic configured to determine the base DSNU offset, the differential DSNU offsets, the base PRNU gain and the differential PRNU gains, such logic will reside in a memory. Such a memory can be implemented as any one of the above-described embodiments for computer-readable medium used for the calibration RAM 208.

Furthermore, for convenience of illustration and for convenience of describing the present invention, the calibration RAM 208 was described as a stand-alone, dedicated memory element. The calibration RAM 208 may reside in any alternative convenient location within image capture device 200 or as components of other systems accessible by the image capture device 200. For example, a multi-purpose memory element may reside in the image capture device 200. A suitably-sized and configured portion of the multi-purpose memory element may be allocated for storing the base DSNU offset, the differential DSNU offsets, the base PRNU gain and the differential PRNU gains as determined in accordance with the present invention.

What is claimed:

1. A method for compensating for noise in image information, the method comprising:
receiving test information for a plurality of pixels;
determining a base compensating value based upon the test information;
determining a plurality of differential compensating values, each differential compensating value based on a difference between the test information for each of the corresponding pixels and the base compensating value; and
storing the base compensating value and the plurality of differential compensating values.

2. The method of claim 1, wherein determining the plurality of differential compensating values further comprises determining each differential compensating value to be equal to a difference between the test information for each of the corresponding pixels and the base compensating value.

3. The method of claim 1, further comprising determining the base compensating value based on the test information from a selected one of the plurality of pixels.

4. The method of claim 1, further comprising capturing at least a portion of an image such that the plurality of pixels generates image information corresponding to the image.

5. The method of claim 4, further comprising:
adding the base compensating value to each of the differential compensating values to determine a plurality of compensation values that uniquely correspond to each of the pixels; and
modifying the image information with the determined compensation values.

6. The method of claim 1, wherein storing further comprises:
storing the base compensating value in a memory residing in an adder; and
storing the differential compensating values in a calibration memory.

7. The method of claim 1, further comprising performing a dark signal calibration test.

8. The method of claim 7, wherein performing the dark signal calibration test further comprises receiving test information from the plurality of pixels when the pixels are accumulating charge in the absence of light.

9. The method of claim 1, wherein the receiving further comprises receiving test information from the plurality of pixels when the pixels are accumulating charge in the absence of light.

10. The method of claim 1, wherein the determining further comprises determining a base dark signal non-uniformity (DSNU) compensating value corresponding to the test information from the selected pixel.

11. The method of claim 10, wherein the determining further comprises determining a plurality of differential DSNU compensating values by taking the difference between the test information from each of the pixels and the base DSNU compensating value.

12. The method of claim 11, further comprising:
adding the base DSNU compensating value to each of the differential DSNU compensating values to determine a plurality of DSNU compensation values that uniquely correspond to each of the pixels; and
combining the determined plurality of DSNU compensation values with corresponding captured image information from the pixels.

13. The method of claim 1, further comprising performing a light signal calibration test.

14. The method of claim 13, wherein performing the light signal calibration test further comprises:
illuminating a reference image; and
receiving test information from the plurality of pixels when the pixels are accumulating charge during illumination of the reference image.

15. The method of claim 1, wherein the receiving further comprises receiving test information from the plurality of pixels when the pixels are accumulating charge during illumination of a reference image.

16. The method of claim 1, wherein the determining further comprises determining a base photo response non-uniformity (PRNU) compensating value corresponding to the test information from the selected pixel.

17. The method of claim 16, wherein the determining further comprises determining a plurality of differential PRNU compensating values by taking the difference between the test information from each of the pixels and the base PRNU compensating value.

18. The method of claim 17, further comprising:
adding the base PRNU compensating value to each of the differential PRNU compensating values to determine a plurality of PRNU compensation values that uniquely correspond to each of the pixels; and
multiplying the determined plurality of PRNU compensation values with corresponding captured image information, from the pixels.

19. The method of claim 1, further comprising:
defining the base compensating value as the sum of a previous base compensating value plus a previous differential compensating value; and
determining a current differential compensating value by taking the difference between light information from a current pixel and the base compensating value.

20. The method of claim 19, further comprising:
adding the base compensating value and the current differential compensating value to define a current compensation value; and
modifying captured image information corresponding to the current pixel with the current compensation value.

21. The method of claim 1, further comprising defining the current compensation value as a next base compensation value such that when captured image information corresponding to a next pixel is modified, the next base compensation value is added to the current differential compensating value associated with the next pixel to determine the current compensation value for the next pixel.

22. The method of claim 1, wherein receiving test information further comprises receiving test information from the plurality of pixels residing in at least one linear charge-coupled device (CCD).

23. The method of claim 22, wherein receiving test information further comprises receiving test information from the plurality of pixels sensitive to a preselected color of light.

24. The method of claim 1, wherein receiving test information further comprises receiving test information from the plurality of pixels residing in a matrix charge-coupled device (CCD).

25. The method of claim 1, wherein receiving test information further comprises receiving test information from the plurality of pixels residing in at least one linear complimentary metal-oxide semiconductor (CMOS).

26. The method of claim 1, wherein receiving test information further comprises receiving test information from the plurality of pixels residing in a matrix complimentary metal-oxide semiconductor (CMOS).

27. The method of claim 1, wherein receiving test information, further comprises receiving test information from the plurality of pixels sensitive to a preselected color of light.

28. A system that compensates for noise in image information, comprising:
a plurality of pixels;
a memory configured to store at least a plurality of differential compensating values;
a processor configured to process test information received from the plurality of pixels during a calibration test, configured to determine a base compensating value from test information received from a selected pixel, and further configured to determine the plurality of differential compensating values such that each differential compensating value based on a difference between the test information from each of the corresponding pixels and the base compensating value;
an adder configured to generate a compensation value for each of the plurality of pixels by adding the base compensating value to each corresponding differential compensating value; and
a combining element configured to combine captured image information received from the plurality of pixels with corresponding compensation values.

29. The system of claim 28, wherein the calibration test is a dark signal calibration test.

30. The system of claim 28, wherein the base compensating value is a base dark signal non-uniformity (DSNU) offset, wherein the differential compensating value is a differential DSNU offset and wherein the compensating value is a DSNU compensating offset value.

31. The system of claim 30, wherein the combining element comprises a second adder configured to subtract the DSNU compensating offset values with corresponding captured image information received from the plurality of pixels.

32. The system of claim 28, wherein the calibration test is a light signal calibration test.

33. The system of claim 28, wherein the base compensating value is a base photo response non-uniformity (PRNU) gain, wherein the differential compensating value is a differential PRNU gain and wherein the compensating value is a PRNU compensating gain value.

34. The system of claim 33, wherein the combining element comprises a multiplier configured to multiply the PRNU compensating gain values with corresponding captured image information received from the plurality of pixels.

35. The system of claim 28, further comprising a linear charge-coupled-device (CCD) such that the plurality of pixels reside in the linear CCD.

36. The system of claim 28, further comprising a plurality of linear charge-coupled-devices (CCDs), wherein a portion of the plurality of pixels reside in each one of the linear CCDs and the portion of pixels is sensitive to a preselected color of light.

37. The system of claim 28, further comprising a matrix charge-coupled device (CCD), wherein the plurality of pixels reside in the matrix CCD, and wherein the plurality of pixels comprise a plurality of portions such that each portion of pixels is sensitive to a preselected color of light.

38. The system of claim 28, further comprising at least one linear complimentary metal-oxide semiconductor (CMOS) such that the plurality of pixels reside in the linear CMOS.

39. The system of claim 28, further comprising a matrix linear complimentary metal-oxide semiconductor (CMOS), wherein the plurality of pixels reside in the matrix CMOS, and wherein the plurality of pixels comprise a plurality of portions such that each portion of pixels is sensitive to a preselected color of light.

40. The system of claim 28, wherein the processor is a control application specific integrated circuit (ASIC).

41. The system of claim 28, wherein the memory element is a calibration random-access memory.

42. The system of claim 28, further comprising a memory element residing in the adder and configured to store the base compensating value.

43. The system of claim 28, further comprising a memory element residing in the adder and configured to store at least one of the plurality of differential compensating values.

44. A computer-readable medium having a program for compensating for noise in image information, the program comprising logic configured to:
receive test information for a plurality of pixels;
determine a base compensating value based upon the test information from a selected one of the plurality of pixels;
generate a plurality of differential compensating values, each differential compensating value based on a difference between the test information from each of the corresponding pixels and the base compensating value;
store the differential compensating values in a memory; and
communicate an instruction so that each of the differential compensating values is communicated to an adder, wherein the base compensating value is added to each differential compensating value to determine a compensation value that modifies captured image information from the plurality of pixels.

45. A system for compensating for noise in image information, comprising:
means for performing a calibration test;
means for receiving test information for a plurality of pixels, the test information corresponding to charge information accumulated by each pixel during the calibration test;
means for determining a base compensating value corresponding to the test information from a selected pixel; and
means for generating a plurality of differential compensating values, each differential compensating value equal to a difference between the test information from each of the corresponding pixels and the base compensating value.

46. The system of claim 45, wherein the means for performing further comprises means for performing the calibration test in the absence of light.

47. The system of claim 45, wherein the means for determining further comprises means for determining a base dark signal non-uniformity (DSNU) compensating value corresponding to the test information from the selected pixel.

48. The system of claim 45, wherein the means for generating further comprises means for generating a plurality of differential DSNU compensating values by taking the difference between the test information from each of the pixels and the base DSNU compensating value.

49. The system of claim 45, wherein the means for performing further comprises means for performing the calibration test by illumination of a reference image.

50. The system of claim 45, wherein the means for determining further comprises means for determining a base photo response non-uniformity (PRNU) compensating value corresponding to the test information from the selected pixel.

51. The system of claim 45, wherein the means for generating further comprises means for generating a plurality of differential PRNU compensating values by taking the difference between the test information from each of the pixels and the base PRNU compensating value.

52. The system of claim 45, further comprising means for capturing at least a portion of an image such that the plurality of pixels generate image information.

53. The system of claim 52, further comprising means for adding the base DSNU compensating value to each of the differential DSNU compensating values to generate a plurality of DSNU compensation values that uniquely correspond to each of the pixels.

54. The system of claim 52, further comprising means for combining the generated plurality of DSNU compensation values with the corresponding image information from the pixels.

55. The system of claim 52, further comprising means for adding the base PRNU compensating value to each of the differential PRNU compensating values to generate a plurality of PRNU compensation values that uniquely correspond to each of the pixels.

56. The system of claim 52, further comprising means for multiplying the generated plurality of PRNU compensation values with the corresponding image information from the pixels.
